(19) United States
(12) Patent Application Publication
(10) Pub. No.: US 2012/0210366 A1
(43) Pub. Date: Aug. 16, 2012

(54) INTERNET CONTENT SUBSCIPTION SERVICE VIA MULTIPLE DEVICES

(75) Inventors: Ling Jun Wong, Escondido, CA (US); True Xiong, San Diego, CA (US); Charles McCoy, Coronado, CA (US); Leo Pedlow, Ramona, CA (US)

(73) Assignees: Sony Network Entertainment International LLC, Los Angeles, CA (US); Sony Corporation, Tokyo (JP)

(21) Appl. No.: 13/077,737

(22) Filed: Mar. 31, 2011

Related U.S. Application Data
(60) Provisional application No. 61/442,153, filed on Feb. 11, 2011.

(51) Int. Cl. H04N 5/445

(52) U.S. Cl. 725/56

(57) ABSTRACT

Subscribing to channels and playing content, including: selecting an available subscription channel with an application on a second device; modifying a user's, subscription list based on the selected subscription-channel; and executing commands on any of the subscription channels of the user's subscription list. Keywords include: media, internet content, BIVL subscription and device infrastructure.

### CROSS-REFERENCE TO RELATED APPLICATIONS

This application claims the benefit of priority of co-pending U.S. Provisional Patent Application No. 61/442,153, filed Feb. 11, 2011, entitled “BIVL Subscription Service Via Second Device.” The disclosure of the above-referenced patent application is incorporated herein by reference.

### BACKGROUND

1. Field of the Invention

The present application relates to internet video services, and more specifically, to subscribing to media content over multiple devices.

2. Background

Internet video services such as Bravia Internet Video Link (BIVL) enable users to browse and search content on the Internet. The browsing and searching can be done using Internet Protocol television (IPTV) which uses the architecture and networking methods of the Internet Protocol Suite over a packet-switched network infrastructure.

Many times media content via BIVL must be browsed, searched, or played oh a single device, usually an IPTV client, making the viewing experience for the user disruptive or inconvenient. Often the content being played on the main device, must be interrupted in order to browse content, which detracts from the viewing experience. Also, some devices that lack GUI capabilities (e.g. a home audio or video device that only displays text) may not be able to browse BIVL services with an IPTV simply because they lack the ability to display a GUI or graphics to a user.

### SUMMARY

Implementations of the present application provide for a user interface that can be used over multiple devices.

In one implementation, provided is a method for subscribing to channels and playing content, including: selecting an available subscription channel with an application on a second device; modifying a user's subscription list based on the selected subscription channel; and executing commands on any of the subscription channels of the user's subscription list.

In another implementation, provided is a non-transitory storage medium storing a computer program for subscribing to channels and playing content, the computer program comprising executable instructions that cause a computer to perform a method including: selecting an available subscription channel with an application, on a second device; modifying a user's subscription list based on the selected subscription channel; and, executing commands on any of the subscription channels of the user's subscription list.

In yet another implementation, provided is a system to allow subscribing to channels and playing of content over multiple devices including: a main device used for playing content; at least one second device used for browsing content; and ah internet protocol television server connected to the main device and to the at least one second device.

Other features and advantages of the present application will become more readily apparent to those of ordinary skill in the art after reviewing the following detailed description and accompanying drawings.

### BRIEF DESCRIPTION OF THE DRAWINGS

FIG. 1 is a flowchart illustrating a process for subscribing to a subscription channel of a user's friend in accordance with one implementation of the present application.

FIG. 2 shows a content transaction system configured to enabling a user browsing media content on one device to have the selection played by another device.

FIG. 3A illustrates a representation of a computer system and a user.

FIG. 3B is a functional block diagram illustrating the computer system hosting a session synchronizer.

### DETAILED DESCRIPTION

Certain implementations as disclosed herein provide for a user interface for multiple devices. After reading this description it will become apparent how to implement the present application in various alternative implementations and alternative applications. However, although various implementations of the present invention will be described herein, it is understood that these implementations are presented by way of example only, and not limitation. As such, this detailed description of various alternative implementations should not be construed to limit the scope or breadth of the present application.

Apparatuses, systems and methods are provided to implement a technique to enable a user browsing media content on one device (e.g., a second device) to have the selection played by another device (e.g., a main device such as an IPTV client). The user can then continue to browse the media content on any number of additional devices without interrupting the content that is being played on the main device.

In one implementation, a user of an IPTV client is allowed to subscribe to a BIVL channel of another user (e.g., another IPTV client) using the second device infrastructure. For example, when a user of an IPTV client adds an asset to the BIVL channel, other users who subscribe to this channel will receive a notification of the changes. The other users will also be allowed to enter the channel to view the changes or play the content directly on the IPTV device using the notification.

In one implementation, when a first user adds a subscription channel of a second user, the channel of the second user appears in the first user's list of channels as a BIVL service (displayed on the second device). The logo for that BIVL service (or any other peripheral image of that logo) may include the notification alert of a list change, if any.

The popularity of IPTV can be increased by providing a solution to the difficulty of navigating around (e.g., browsing and searching BIVL content) on a main display without disturbing the viewing experience of the main display of other users who are watching. There are issues, associated with viewing and browsing content on a single main device suck as cumbersome data entry, limitations in memory and processing power, and difficulties in effective; content searches, which ail remain as obstacles. However, by providing a second device as a visual aid to the main device of the IPTV client, the user's viewing, experience can be enhanced. The cost for this enhanced viewing experience can also be reduced by using devices such as cellphones, laptops, and other portable devices, which are already owned by most users, as a second device. By allowing the user to send the content for playback on the IPTV client only when the user is ready to watch it, the security risks are substantially reduced because the playback of proprietary content does not occur on a non-authenticated second device. The security risk is essentially the exposure of a content URL to public eyes, which leads to a loss of proprietary content, because the content URL is never found on the second device. In other words, the IPTV device may receive the URL of content from the proxy server and then may use that URL to play the content directly from the service provider. Since the URL may not be available to the application running on the second device, a hacker who edits an application on the second device does not have an opportunity to obtain the content URL and therefore does not have the ability to download and distribute the content. Thus, the code that is running on the second device is not vulnerable to hackers. The second device may not be authenticated, unless it is ingested into a media system in which case it becomes a main device instead of a second device. Hence, the second device may browse (with limited playback of non-proprietary content, for example) on behalf of the main device. When playback is requested, an ID is sent over to the main device which uses that ID to retrieve the content URL. In this way, the content URL is never found on the second device. Further, since the web application of the second device is usually written in, for example, HTML, it can be loaded by any device with a browser.

In one implementation, a second device corresponding to the IPTV client is used to subscribe to a BIVL channel of another user. For example, when a user adds an asset to the BIVL channel, other users who subscribe to this channel will receive a notification of the addition of the asset. The other users will also be allowed to enter the channel to view the asset that has been added.

In another implementation, a method of subscribing to a BIVL channel of another user using the second device corresponding to the IPTV client is described. When a user adds a subscription channel of another user, the channel of another user appears in the user's list as a BIVL service. For this to work, the user (using the second display) may have already established a friends list using a normal “add friends” mechanism typical for a social networking system. In this case, the user loads a web application for the second device. The user then uses the web application to search for or view channels or contents lists that a friend has published. The user can then subscribe to one or more of these channels or content lists of a friend, adding a subscription to a channel or content list to the user's own subscription list. The subscription list of the user is then refreshed and shows the subscribed channels or content lists of the friend in the user's own subscription list. The user then enters their subscription list and browses it like a normal BIVL service. In other words, the user may not have access to view their friend's subscription list, but may have access to view and to subscribe to the channels or content lists that their friends may publish—which may be either to other friends or to the general public. In one implementation, a single service is shown that list all of the user's subscriptions, and where new subscriptions show up. Such a service may be browsed on both the second device and on the main device (e.g., IPTV client). As before, the second device to IPTV client playback flow is used to perform playback, or in other words, the second device sends a playback signal to the IPTV client to play the content without disrupting the viewer's experience of the IPTV client (by having to switch screens to browse/select content, for example). When a friend adds content to that list, the addition of the content is reflected as an alert on the service logo, informing the user that there is a new addition to the list.

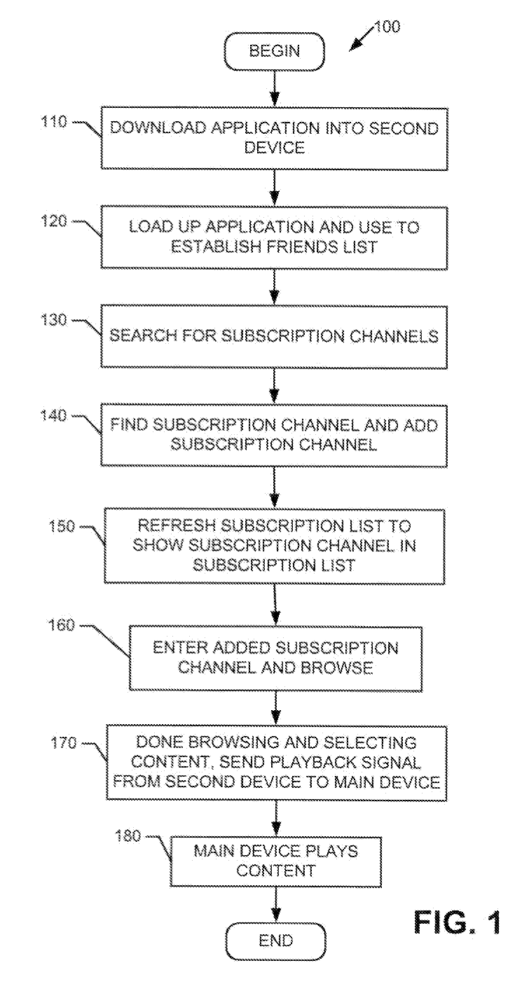

FIG. 1 is a flowchart illustrating a process 100 for subscribing to a subscription channel of a user's friend in accordance with one implementation of the present application. The main device, in one implementation, is an IPTV client. In one implementation, the main device may not have a GUI and may be, for example, a home audio or Video device with only text-based input. In another implementation, the main device, may not have a GUI and may be, for example, a device that only takes audio-based or speech input. In one implementation, the second device may be a cellphone, a laptop, and other portable devices or device having a GUI.

In box 110, an application is downloaded into the second device. In one implementation, a web application may be used for the application. In one implementation, a web application is not used and a different type of application such as a binary application is used which may be pre-installed and downloaded into the second device. In one implementation, the application provides the social networking software necessary for a user to add friends, search for friends, and view or add the subscriptions channels of friends. In one implementation, a user can search for friends and add friends via a web site. Once the application is downloaded, the user can load the application and use it to add friend and establish a friends list. In one implementation, the application is a web application that may be downloaded before adding or searching friends can occur. In one implementation, if the application is written as a native binary application, such download may not be needed. There are a variety of ways that the application can be implemented including compiled methods that create a binary application, such, as C, C++, Objective C, or Java, and interpreted methods, such as Perl scripts or HTML/JavaScript web applications. Regardless of how the application is implemented the application can be preloaded on the second device or downloaded from a server either on request by the user or every time the application is executed. In one implementation, the application can be loaded into the second device by being, for example, downloaded from another source or pre-installed by the manufacturer on the second device.

In box 120, the application is loaded and used to establish a friends list. In one implementation, the application may have been already downloaded and then loaded before, and then used to add friends to establish a friends list.

In box 130, the application may be used to search for subscription channels, for example, the subscription channel of friends in the friends list. In one implementation, users may also browse through and subscribe to subscription channels that ware made public by users who are not necessarily associated with the user as a friend. In one implementation, each friend on the friends list may also have at least one subscription channel, or more than one subscription channel. In one implementation, subscription channels can be searched by keywords or names or by using other search techniques to find, for example, a specific friend on the friend list. In one implementation, specific subscription channels may be searched by channel type, content, material, date created, and other parameters.

In box 140, a subscription channel is found and then added to a user's account. In one implementation, the found subscription channel or content list may belong to a friend of the user. Therefore, the added subscription channel is now part of the user's account or user's own subscription list, and can be browsed as content that belongs to the user. In one implementation, some content in the added subscription channel, may be viewed by the user, or in other words, the user may not have access to all of the content in the subscription channel. For example, some of the items in the subscription channel may only be available to users who have a subscription that the user does not have, or to a particular content providers service. Another example is that some content may be available in some countries or regions, but not others. If a user adds content to such a content channel, a subscriber to that content channel is a country where that content cannot be shown will not be able to watch that content.

In box 150, the user's subscription list is refreshed to show the, added subscription channel in the subscription list. A subscription channel may also be similar to a content channel that includes content published by users that other users can view even if that content may not be in list form. Such a list could be described as a list of content and/or criteria for selecting content, such as a set of tags or search terms. If the user sets the privacy settings of their content channel to make it visible to friends or the general public, then the users who have permission to view it can then subscribe to it. The viewers may see in their subscription list when they have a subscription with new content, possibly as a count of subscriptions with new content items shown in the navigation links used for accessing their subscriptions. Each subscription in the list may also be displayed in a number of ways to indicate which subscriptions have new content available, possibly by displaying a count of the number of new content items. For example, a number in parentheses could be placed at the end of a link used to navigate to the content when there is new content, where the number may indicate the number of pieces of new (or not viewed yet) content that the user can access by following that link. Another example would be to place an icon in a particular place anytime when there is any quantity of new content available, for instance, an envelope icon that appears in a task bar when new email messages are available. In one implementation, the user can update each subscription to indicate that they wish to receive a message sent to them when there is new content available in a given subscription.

In one implementation, a user's “subscription list” could also contain a list of subscription channels. These channels can be another user's personal subscription channel (which that user can control) or another user's subscribed subscription channel (which the user has no control over), if permissions are allowed. This means that User A can add all the channels that User B has subscribed to.

In one implementation, a content URL can also be part of the subscription channel in addition to a regular BIVL asset. A content URL may be a raw URL to a media file, which may be encountered on a web site, for example, and is an asset that is provided by the user. The URL may also refer to content that is available on the local network, such as media that the user placed on a shared drive or media server. The content for the content URL may be owned by the user or found publicly on the Internet. Furthermore, BIVL content may be the content for the content URL and is available through the BIVL system and may be limited to the assets a user can browse through BIVL. A BIVL asset provided for a content URL may be provided by service providers in the internet content infrastructure, and is most often proprietary. BIVL content also has associated meta-data and the actual URL of a media file may not be made available to a user. A subscription list may contain a mixture of raw URLs and references to BIVL content. Also, in one implementation, when the user's subscription list has added the friend's subscription channel, the user's subscription list can also be seen and used on the main device's service list as well, and it may comply with standard BIVL protocols. Therefore, in one implementation, browsing, managing and searching for subscription content may not be limited only to application domain of the second device. Browsing subscriptions may also be done directly on the main device (e.g. IPTV client) itself.

In box 160, the friend's subscription channel may be entered and browsed, just like a normal BIVL service, for example, where the content is perused and selected. Content can include, for example, movies, music, video games, still images, applications, media and/or other content that can be purchased or free that may be downloaded, viewed, or streamed. In box 170, when browsing is completed and all desired content, has been selected, a playback signal is sent from the second device to the main device. This is a second device to main device playback flow that does not disrupt the actual playback of the main device, by having it, for example, go to another screen for browsing or selection purposes.

In box 180, the main device plays the content that has been selected and sent by the second device. In one implementation, when a friend (whose subscription channel has been added to the user's subscription list) adds content to his or her channel, this new change will be reflected as “an alert” on the BIVL service logo, for example, informing the user that there are new additions to the user's subscriptions, as discussed in the examples for displaying new content to a user shown above. In one implementation, the service logo may look different to indicate that a notification is available compared to the case where there is rib notification. In one implementation, the description of the service may also state how many notifications there are. Pressing options (or other similar actions) on that service, instead of entering the service, may provide the user the choice to directly play or view the description of the new addition, if any, instead of going into the service.

In one implementation, the above-described process 100 may be implemented on the platform of the main device or IPTV client itself, but that may require a huge software change once, there is a change in a platform (BDP, DTV, etc.). In one implementation, the above-described process 100 may be implemented on the second device because it only requires implementation and an update in one place. By implementing the client on a second device, existing IPTV devices without support for subscriptions can take advantage of subscriptions without a code change if the user establishes those subscriptions on a second device. The subscriptions can be browsed on the IPTV device as they will be presented using the same format as the existing content services. Software can be added to existing or new IPTV devices to also allow users to manage their subscriptions directly on their IPTV devices. In one implementation, subscriptions may also be managed on existing IPTV devices, but the interface for such a set-up would be different than if such an interface were designed as a feature of the client software itself.

In one implementation, the IPTV may also have many other functions which are unrelated to this feature. The software update for the IPTV may contain the binary for the other functions as well, which results in greater bandwidth costs. Furthermore, all platforms will have to make a change and update separately, unlike the second device which may have a single binary code that controls all the devices.

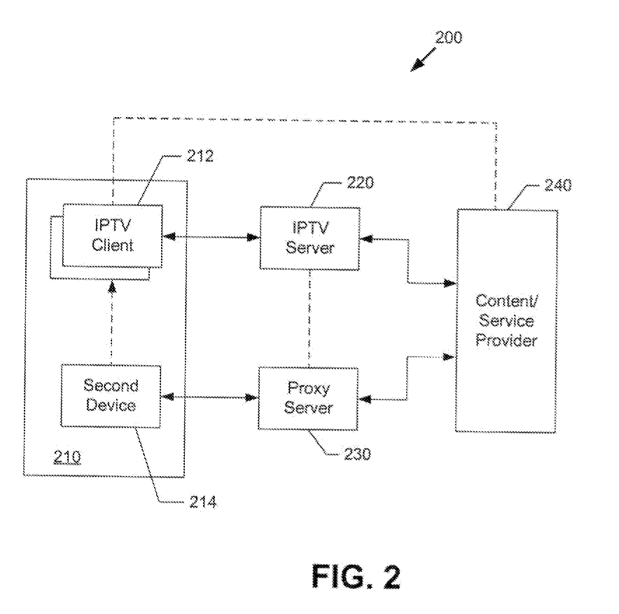

FIG. 2 shows, a content transaction system 200 configured to enabling a user browsing-media content on one device to have the, selection played by another device. In one implementation, the content, transaction system 200 includes an IPTV client 212 and a second device 214 configured, within a local network 210, which are in communication with an IPTV server 220 and a proxy server 230. The servers 220, 230 are in communication with a content/service provider 240.

The user loads a web application in the second device 214 and logs into an account in the proxy server 230. Once logged into the account, the second device 214 receives a list of compatible IPTV clients 212. Using the second device, the user selects an IPTV client 212. A list of services available to the client 212 is shown on the display of the second device 214. The user can browse and search services and content in the preferred language of the user. For security reasons, BIVL content transaction between the second device 214 and the content/service provider 240 occurs oh the proxy server 230 to create a firewall. When content is selected by the user using the second device 214, the content will be sent to the IPTV client 212 for playback. However, the second device 214 may send a reference identifier for the selected content to the IPTV client 212, which retrieves the content using the reference identifier. In one implementation, the IPTV client 212 may send the reference, identifier to the proxy server 230.

The authenticated IPTV client 212 sends the reference identifier to the IPTV server 220 which in turn sends it to the content/service provider 240. The IPTV client 212 receives the content selected by the second device 214 from the content/service provider 240 through the IPTV server 220. In brie implementation, the IPTV client 212 sends a reference to the IPTV server 220, and the IPTV server 220 responds with information about the reference. The IPTV client 212 receives the content selected by the second device directly from the content/service provider 240 and the IPTV client 212 may contact the content/service provider 240 directly for this information. Thus, the unauthenticated second device 214 is not given access to the content URL to reduce the risk of exposing proprietary information. During playback, the user using the second device 214 continues to browse, search, select, and queue other content for future playback without interrupting the content that is being played on the IPTV client 212. In one implementation, both the selected IPTV client 212 and the second device 214 must be in the same local network 210 in order to perform a playback of the selected content. The user can also switch clients 212 and resume playback on a different client by selecting from a recently viewed list the last media content played and after switching control to that device. In one implementation, the IPTV client 212 may play media directly from the content/service provider 240. Media can include, for example, BIVL content.

In one implementation, the filtering of content available through a subscription channel based oh the content that can be played by the device using, the subscription channel is provided. This covers the fact that some of the content in the subscription channel may be available in the creator's country or region, but hot where the playback device is located. The playback device may lack the software or hardware support to play media in certain formats, and therefore this may be content that may be filtered out. The rating limits on the playback device set by the user for given content may also prevent that device from playing some content.

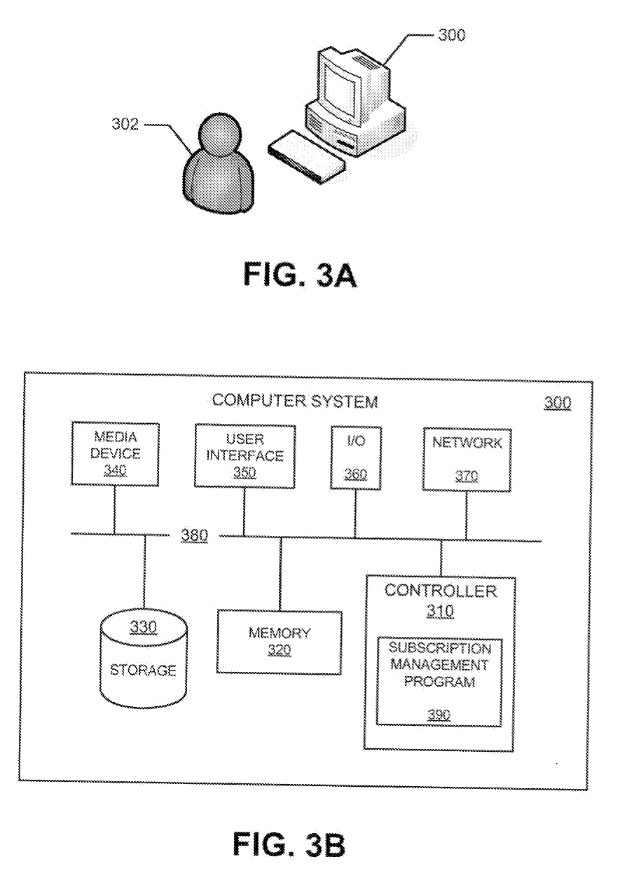

FIG. 3A illustrates a representation of a computer system 300 and a user 302. The user 302 may use the computer system 300 to browse, select and play content across multiple devices. The computer system 300 stores and executes an subscription management program 390.

FIG. 3B is a functional block diagram illustrating the computer system 300 hosting the subscription management program 390. The controller 310 is a programmable processor and controls the operation of the computer system 300 and its components. The controller 310 loads instructions (e.g., in the form of a computer program) from the memory 320 or an embedded controller memory (not shown) and executes these instructions to control the system. In its execution, the controller 310 provides the subscription management program 390 as a software system.

Alternatively, this service can be implemented as separate hardware components in the controller 310 or the computer system 300.

Memory 320 stores data temporarily for use by the other components of the computer system 300. In one implementation, memory 320 is implemented as RAM. In one implementation, memory 320 also includes long-term or permanent memory, such as flash memory and/or ROM.

Storage 330 stores data temporarily or long term for use by other components of the computer system 300, such as for storing data used by the subscription management program 390. In one implementation, storage 330 is a hard disk drive.

The media device 340 receives removable media and reads and/or writes data to the inserted media. In one implementation, for example, the media device 340 is an optical disc drive.

The user interface 350 includes components for accepting user input from the user of the computer system 300 and presenting information to the user. In one implementation, the user interface 350 includes a keyboard, a mouse, audio speakers, and a display. The controller 310 uses input from the user to adjust the operation of the computer system 300.

The I/O interface 360 includes one or more I/O ports to connect to corresponding I/O devices, such as external storage or supplemental devices (e.g., a printer or a PDA). In one implementation, the ports of the I/O interface 360 include ports such as: USB ports, PCMCIA ports, serial ports, and/or parallel ports. In another implementation, the I/O interface 360 includes a wireless interface for communication with external devices wirelessly.

The network interface 370 includes a wired and/or wireless network connection, such as an RJ-45 or “Wi-Fi” interface (including, but not limited to 302.11) supporting an Ethernet connection.

The computer system 300 includes additional hardware and software typical of computer systems (e.g., power, cooling, operating system), though these components are not specifically shown in FIG. 3B for simplicity. In other implementations, different configurations of the computer system can be used (e.g., different bus or storage configurations or a multi-processor configuration).

One implementation includes one or more programmable processors and corresponding computer system components to store and execute computer instructions, such as subscribing to a BIVL channel, of another user using the second device corresponding to the IPTV client.

Additional variations and implementations are also possible. For example, the examples focus on an IPTV client and browsing of the BIVL content, but devices other than an IPTV client can be used as a main device and the second device can browse and search for content other than the BIVL content. In one variation, a content URL can also be a part of the subscription channel in addition to a regular BIVL asset. In another variation, when the subscription list is done on the second device, the list can also be seen and used on the IPTV client's service list as well (as it complies with standard BIVL protocols). Thus, this is not limited only to the second device web application domain. In yet another variation, the above-described feature can also be implemented on the platform itself. However, it will require a software change on each platform (e.g., BDP, DTV, etc) in order to utilize this feature. Accordingly, the technology is not limited only to the specific examples noted herein.

The above description of the disclosed implementations is provided to enable any person skilled in the art to make or use the present application. Various modifications to these implementations will be readily apparent to those skilled in the art, and the generic principles described herein can be applied to other implementations without departing from the spirit or scope of the invention. Accordingly, additional implementations and variations are also within the scope of the invention. Further, it is to be understood that the description and drawings presented herein are merely representative of the subject matter which is broadly contemplated by the present application. Thus, the present application is not intended to be limited to the implementations shown herein but is to be accorded the widest scope consistent with the principal and novel features, disclosed herein.

Various implementations of the present application, are realized in electronic hardware, computer software, or combinations of these technologies. Some implementations include one or more computer programs executed by one or more computing devices. In general, the computing device includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a persistent storage medium and then copied into memory at run-time. At least one processor executes the code by retrieving program instructions from memory in a prescribed order. When executing the program code, the computer receives data from the input and/or storage devices, performs operations on the data, and then, delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software, depends upon the particular application and design constraints imposed oh the overall system. Skilled persons can implement the described functionality in varying ways for each particular application, but such implementation decisions should not be interpreted as causing a departure, from the scope of the present application. In addition, the grouping of functions within a module or step is for ease of description. Specific functions, can be moved from one module or step to another without departing from the present application.

Additionally, the steps of a method or technique described in connection with the implementations disclosed herein can be embodied directly in hardware, in a software module executed by a processor, or in a combination of the two. A software module can reside in RAM memory, flash memory, ROM memory, EP-ROM memory, EEPROM memory, registers, hard disk, a removable disk, a CD-ROM, or any other form of storage medium including a network storage medium. An example storage medium can be coupled to the processor such that the processor can read information from, and write information to, the storage medium. In the alternative, the storage medium can be integral to the processor. The processor and the storage medium can also reside in an ASIC.

All features of each above-discussed example are hot necessarily required in a particular implementation of the present application. Further, it is to be Understood that the description and drawings presented herein are representative of the subject matter which is broadly contemplated by the present application. It is further understood that the scope of the present application fully encompasses other implementations that may become obvious to those skilled in the aft and that the scope of the present application is accordingly limited by nothing other than the appended claims.

1. A method for subscribing to channels and playing content, comprising:
selecting ah available subscription channel with an application on a second device;
modifying a user's subscription list based on the: selected subscription channel; and
executing commands on any of the subscription channels of the user's subscription list.

2. The method of claim 1, Wherein the application is loaded into the second device.

3. The method of claim 1, wherein the second device comprises a laptop, cellphone, a desktop computer, or other portable device that supports a graphical user interface.

4. The method of claim 1, wherein selecting an available subscription channel with an application on the second device comprises:
building a friends list with the application; and
using a search technique to find the available subscription channel on the friends list.

5. The method of claim 1, wherein selecting an available subscription channel with an application on the second device comprises:
using a search technique to find the available subscription channel on all channels publicly available.

6. The method of claim 1, wherein modifying a user's subscription list based on the selected subscription channel comprises:
adding the selected subscription channel to the user's subscription list; and
removing the selected subscription channel to the user's subscription list.

7. The method of claim 1, wherein executing commands on any of the subscription channels Of the user's subscription list comprises:
selecting assets from asset purchase transactions made by the user to purchase assets, the assets comprising movies, music, video games, still images, applications, media and other content that can be purchased.

8. The method of claim 1, wherein executing commands on any of the subscription channels of the user's subscription list comprises:
selecting content on the second device, the content comprising movies, music, video games, still images, applications, and media.

9. The method of claim 8, further comprising:
sending a play request from the second device to a main device to play the selected content; and
playing the selected content on the main device, wherein the main device comprises an IPTV client, optical disk player, a TV, a home audio or video device, or any display device that lacks a graphical user interface.

10. A non-transitory storage medium storing a computer program for subscribing to channels and playing content, the computer program comprising executable instructions that cause a computer to perform a method comprising:
selecting an available subscription channel with an application on a second device;
modifying a user's subscription list based on the selected subscription channel; and
executing commands on any of the subscription channels of a user's subscription list.

11. The non-transitory medium of claim 10, wherein the application is loaded into the second device.

12. The non-transitory medium of claim 10, wherein the second device comprises a laptop, cellphone, a desktop computer, or other portable device that supports a graphical user interface.

13. The non-transitory medium of claim 10, wherein selecting an available subscription channel with an application on the second device comprises:
building a friends list with the application; and
using a search technique to find the available subscription channel on the friends list or oh all channels publicly available.

14. The non-transitory medium of claim 10, wherein selecting an available subscription channel with ah application on the second device comprises:
using a search technique to find the available subscription channel on all channels publicly available.

15. The non-transitory medium of claim 10, wherein modifying a user's subscription list based on the selected subscription channel comprises:
adding the selected subscription channel to the user's subscription list; and
removing the selected subscription channel to the user's subscription list.

16. The non-transitory medium of claim 10, wherein executing commands on any of the subscription channels of the user's subscription list comprises:
selecting content from asset purchase transactions made by the user to purchase assets, the assets comprising movies, music, video games, still images, media, applications, and other content that can be purchased.

17. The non-transitory medium of claim 10, wherein executing commands on any of the subscription channels of the user's subscription list comprises:
selecting content on the second device, the content comprising movies, music, video games, still images, applications, and media.

18. The non-transitory medium of claim 17, further comprising:
sending a play request from the second device to a main device to pray the selected content; and
playing the selected content on the main device, wherein the main device comprises an IPTV client, optical disk player, a TV, a home audio or video device, or any display device that lacks a graphical user interface.

19. A system to allow subscribing to channels and playing of content over multiple devices comprising:
a main device used for playing content;
at least one second device used for browsing content; and
an internet protocol television server connected to the main device and to the at least one second device.

20. The system of claim 19, wherein the at least one second device comprises a laptop, cellphone, or other portable device that supports a graphical user interface, and the main device comprises an IPTV client, a TV, a home audio or video device, or any display device that lacks a graphical user interface.

21. The system of claim 19, wherein the at least one second device comprises a subscription management program downloaded from the internet protocol television server, the subscription management program allowing subscription of other channels of content.

22. The system of claim 21, wherein a user uses the at least one second device and the other channels of content that can be subscribed to belong to other users of are publicly available.
